(19) United States
(12) Patent Application Publication
(10) Pub. No.: US 2026/0062529 A1
(43) Pub. Date: Mar. 5, 2026

(54) ANTI-SLIP ROD-SHAPED RARE-EARTH-MODIFIED POLYURETHANE MATERIAL AND APPLICATION THEREOF

(71) Applicant: Aleader (longyan) New Material Co., Ltd., Longyan City (CN)

(72) Inventors: WENHUA CHEN, Longyan City (CN); SHENG LONG WANG, Longyan City (CN); QIU MIN ZHENG, Longyan City (CN); CHENG SHUANG LUO, Longyan City (CN); LE PING TAI, Longyan City (CN); LI JUN SONG, Longyan City (CN)

(21) Appl. No.: 19/315,972

(22) Filed: Sep. 2, 2025

(30) Foreign Application Priority Data
Sep. 2, 2024 (CN) 202411219087.1

(51) Int. Cl. C08J 9/00; B29C 39/00; B29C 39/02; B29C 44/02; B29K 75/00; B29L 30/00; C08G 18/24; C08G 18/32; C08K 7/00

(52) U.S. Cl. CPC C08J 9/0066; B29C 39/003; B29C 39/02; B29C 44/025; C08G 18/242; C08G 18/3206; C08K 7/00; B29K 2075/00; B29L 2030/006; C08J 2375/04; C08K 2201/011

(57) ABSTRACT

An anti-slip rod-shaped rare-earth-modified polyurethane material, the anti-slip rod shaped rare-earth-modified polyurethane material is formed by mixing and curing a premixed material and isocyanate, the premixed material is prepared by mixing a rod-shaped rare-earth oxide pre-dispersion solution, polyethylene glycol (PEG) 600, glycerol, a catalyst, water, and color paste, and the rod-shaped rare-earth oxide pre-dispersion solution is prepared by mixing PEG400, a dispersant, a defoamer, and rod-shaped rare-earth oxides.

### RELATED APPLICATIONS

This application claims priority to Chinese patent application 202411219087.1, filed on Sep. 2, 2024. Chinese patent application 202411219087.1 is incorporated herein by reference.

### FIELD OF THE DISCLOSURE

The present disclosure relates to the technical field of polyurethane foam materials, and specifically relates to an anti-slip rod-shaped rare-earth-modified polyurethane material and an application thereof.

### BACKGROUND OF THE DISCLOSURE

The manufacturing process of filled foamed polyurethane solid tires involves injecting two-component stock solutions of polyurethane, including polyether polyol and isocyanate, into a tire mold. At a specific temperature, a mixture of the polyether polyol and the isocyanate undergoes a chemical cross-linking reaction and is finally cured to form a polyurethane clastic solid tire. This tire has many significant advantages: no inflation required, insensitivity to punctures, strong load-bearing capacity, small compression deformation, excellent shock absorption performance, long service life, and a wide range of applications. These characteristics minimize inconvenience caused by tire punctures. In addition, excellent stability and constant pressure effect of the tire further improve a safety of the tire in hazardous environments.

Although the filled foamed polyurethane solid tire has many superior properties, self-skinning effects of the filled foamed polyurethane solid tire causes a relatively smooth tire surface. The filled foamed polyurethane solid tire is inferior to a standard pneumatic tire in terms of ground traction, affecting handling performance and braking distance of a vehicle, especially under a wet and slippery condition. Therefore, domestic-foreign professionals and enterprises have been conducting continuous improvement research.

CN108752910A proposes a solution to improve anti-slip and wear-resistant properties of polyurethane solid tires by adding aramid pulp and tetrafluoroethylene modified materials. This solution leaves no long mark during braking and has strong environmental protection performance and simple preparation materials while prolonging the service life of the polyurethane solid tires. However, specific test data has not been disclosed in this disclosure. In addition, CN106832198A discloses a preparation method of anti-slip polyurethane solid tires for a cold storage environment. This method improves anti-slip effects of the anti-slip polyurethane solid tires at low temperatures by changing a structure of reaction monomers and increasing a content of soft segments in a molecular chain of polyurethane. The aforementioned existing technologies mainly enhance anti-slip performance of the polyurethane solid tires by adding or modifying organic polymer compounds.

### BRIEF SUMMARY OF THE DISCLOSURE

An objective of the present disclosure is to provide an anti-slip rod-shaped rare-earth-modified polyurethane material.

The technical solution of the present disclosure is as follows.

An anti-slip rod-shaped rare-earth-modified polyurethane material, the anti-slip rod-shaped rare-earth-modified polyurethane material is formed by mixing and curing a premixed material and isocyanate, the premixed material is prepared by mixing a rod-shaped rare-earth oxide pre-dispersion solution, polyethylene glycol (PEG) 600, glycerol, a catalyst, water, and color paste, the rod-shaped rare-earth oxide pre-dispersion solution is prepared by mixing PEG400, a dispersant, a defoamer, and rod-shaped rare-earth oxides, and size specifications of the rod-shaped rare-earth oxides are as follows: a length 100-200 μm, a width 2-15 μm, and a thickness 500 nm-5 μm.

In a preferred embodiment of the present disclosure, the rod-shaped rare-earth oxides are at least one of rod-shaped cerium oxide, rod-shaped lanthanum oxide, rod-shaped samarium oxide, rod-shaped neodymium oxide, or rod-shaped yttrium oxide.

In a preferred embodiment of the present disclosure, in the rod-shaped rare-earth oxide pre-dispersion solution, a mass ratio of the PEG400, the dispersant, the defoamer, and the rod-shaped rare-earth oxides is 350-450:1-2:2.5-5:22-32.

In a preferred embodiment of the present disclosure, in the premixed material, a mass ratio of the rod-shaped rare-earth oxide pre-dispersion solution, the PEG600, the glycerol, the catalyst, the water, and the color paste is 384-486.5:467-538:30.5-60:1.5-3:2-4:11-15.

In a preferred embodiment of the present disclosure, a mass ratio of the premixed material and the isocyanate is 5-6:4-5.

In a preferred embodiment of the present disclosure, the catalyst is organotin catalyst T-12.

In a preferred embodiment of the present disclosure, the dispersant is UNIQUE® SPERSE 680, and the defoamer is BYK® 093.

A preparation method of the anti-slip rod-shaped rare-earth-modified polyurethane material, comprising following steps:
(1) mixing the PEG400, the dispersant, and the defoamer to obtain a first uniform material, adding the rod-shaped rare-earth oxides into the first uniform material, continually dispersing until a temperature reaches 50-60° C., continually stirring for 8-12 minutes, stop stirring, and cooling to obtain the rod-shaped rare-earth oxide pre-dispersion solution;
(2) mixing the PEG600, the glycerol, the catalyst, the water, and the color paste to obtain a second uniform material, adding the rod-shaped rare-earth oxide pre-dispersion solution obtained in the step (1) into the second uniform material, and continually stirring for 10-15 minutes to obtain the premixed material; and
(3) mixing the premixed material obtained in the step (2) with the isocyanate to obtain a third uniform material, pouring the third uniform material into a mold, heating the mold to raise a temperature of the mold to 70-80° C. within 2 minutes, immediately stopping heating, and opening the mold after 2-4 minutes to obtain a product.

A method for preparing an anti-slip tire by adding the anti-slip rod-shaped rare-earth-modified polyurethane material into a mold.

An anti-slip tire, wherein the anti-slip tire is made of the anti-slip rod-shaped rare-earth-modified polyurethane material.

The present disclosure has the following advantages.

The present disclosure improves wear resistance and roughness of tires (e.g., foamed tires) through reinforcing effects of rod-shaped rare-earth oxides. Specifically, roughness of a surface of the foamed tires is improved by needle-shaped effects of the rod-shaped rare-earth oxides distributed on a surface of the foamed tires, and friction performance of the foamed tires with the ground, especially with wet and slippery ground, is increased to increase traction by ground-piercing effects of rod-shaped ends. In addition, local rapid foaming effects of the rod-shaped rare-earth oxides are used to control hardness of the foamed tires and to increase a contact area between the foamed tires and the ground under a constant load while increasing wearing resistance of the foamed tires to further improve friction coefficients. Finally, excellent traction of the foamed tires is achieved, and braking distance of the foamed tires on various road surfaces is shortened.

### BRIEF DESCRIPTION OF THE DRAWING

FIG. 1 illustrates a Scanning Electron Microscope (SEM) image of a rod-shaped lanthanum oxide in Embodiment 2 of the present disclosure.

FIG. 2 illustrates a surface photo of a tire product prepared in Comparative Embodiment 2 of the present disclosure.

FIG. 3 illustrates a surface photo of a tire product prepared in Embodiment 2 of the present disclosure.

FIG. 4 illustrates a photo of a braking distance of the tire product prepared in Comparative Embodiment 2 of the present disclosure.

FIG. 5 illustrates a photo of a braking distance of the tire product prepared in Embodiment 2 of the present disclosure.

### DETAILED DESCRIPTION OF THE EMBODIMENTS

The technical solution of the present disclosure will be further clarified and described below through specified embodiments in combination with the accompany drawings.

### Embodiment 1

(1) 409.0 g of Polyethylene Glycol (PEG) 400 with a purity no less than 95%, 1.5 g of UNIQUE® SPERSE 680U used as dispersant, and 2.5 g of BYK®-093 used as defoamer are added into a mixing tank and stirred at a stirring speed of 500 revolutions/minute (r/min) for 15 minutes. 22.0 g of rod-shaped cerium oxide with a purity no less than 95% and size specifications of an average length 100 μm, an average width 8 μm, and an average thickness 2 μm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 50° C. to obtain a rod-shaped rare-earth oxide pre-dispersion solution after ceasing stirring by cooling.

(2) 500.0 g of PEG 600 with a purity no less than 95%, 45.0 g of glycerol, 3.0 g of organotin catalyst T-12 with a solid weight content 18±0.5%, which is purchased from Air Products, US, 2.0 g of grade 3 deionized water, and 15.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 600.0 g of the premixed material obtained in step (2) and 400.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 80° C. within 2 minutes and immediately stopped being heated, and the tire mold is opened after 3 minutes to take out a foamed tire.

(4) The foamed tire obtained in step (3) is trimmed to obtain a tire product.

### Embodiment 2

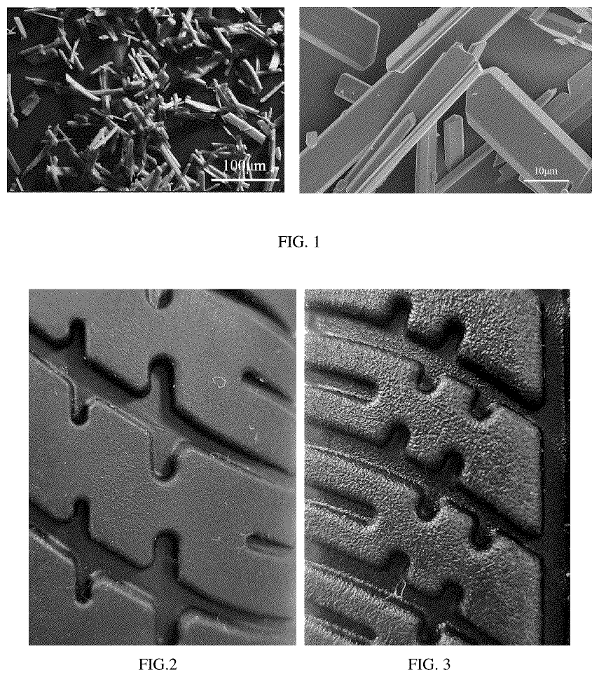

(1) 450.0 g of Polyethylene Glycol (PEG) 400 with a purity no less than 95%, 1.0 g of UNIQUE® SPERSE 680U used as dispersant, and 3.5 g of BYK®-093 used as defoamer are added into a mixing tank and stirred at a stirring speed of 500 revolutions/minute (r/min) for 15 minutes. As shown in FIG. 1, 32.0 g of rod-shaped lanthanum oxide with a purity no less than 95% and size specifications of an average length 160 μm, an average width 15 μm, and an average thickness 1 μm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 60° C. to obtain a rod-shaped rare-earth oxide pre-dispersion solution after ceasing stirring by cooling.

(2) 467.0 g of PEG 600 with a purity no less than 95%, 30.5 g of glycerol, 2.0 g of organotin catalyst T-12 with a solid weight content 18±0.5%, which is purchased from Air Products, US, 3.0 g of grade 3 deionized water, and 11.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 550.0 g of the premixed material obtained in step (2) and 450.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 80° C. within 2 minutes and immediately stopped being heated, and the tire mold is opened after 3 minutes to take out a foamed tire.

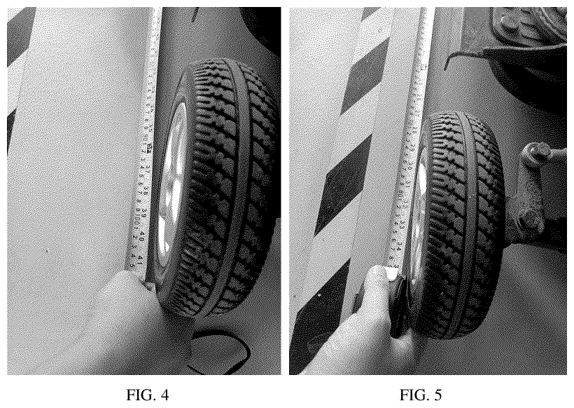

(4) The foamed tire obtained in step (3) is trimmed to obtain a tire product. A surface of the tire product is shown in FIG. 3, and braking distance data of the tire product is shown in Table 1 and FIG. 5.

### Embodiment 3

(1) 350.0 g of Polyethylene Glycol (PEG) 400 with a purity no less than 95%, 2.0 g of UNIQUE® SPERSE 680U used as dispersant, and 5.0 g of BYK®-093 used as defoamer are added into a mixing tank and stirred at a stirring speed of 500 revolutions/minute (r/min) for 15 minutes. 27.0 g of rod-shaped samarium oxide with a purity no less than 95% and size specifications of an average length 200 μm, an average width 2 μm, and an average thickness 500 nm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 60° C. to obtain a rod-shaped rare-earth oxide pre-dispersion solution after ceasing stirring by cooling.

(2) 538.0 g of PEG 600 with a purity no less than 95%, 60.0 g of glycerol, 1.5 g of organotin catalyst T-12 with a solid weight content 18±0.5%, which is purchased from Air Products, US, 4.0 g of grade 3 deionized water, and 12.5 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 500.0 g of the premixed material obtained in step (2) and 500.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 70° C. within 2 minutes and immediately stopped being heated, and the tire mold is opened after 3 minutes to take out a foamed tire.

(4) The foamed tire obtained in step (3) is trimmed to obtain a tire product.

### Comparative Embodiment 1

(1) 450.0 g of Polyethylene Glycol (PEG) 400 with a purity no less than 95%, 1.0 g of UNIQUE® SPERSE 680U used as dispersant, and 3.5 g of BYK®-093 used as defoamer are added into a mixing tank, are stirred at a stirring speed of 500 revolutions/minute (r/min) for 15 minutes, are continually dispersed at a stirring speed of 800 r/min, and are continually stirred for 10 minutes when a temperature of the material reaches 60° C. to obtain a rod-shaped rare-earth oxide pre-dispersion solution after ceasing stirring by cooling.

(2) 499.0 g of PEG 600 with a purity no less than 95%, 30.5 g of glycerol, 2.0 g of organotin catalyst T-12 with a solid weight content 18±0.5%, which is purchased from Air Products, US, 3.0 g of grade 3 deionized water, and 11.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 550.0 g of the premixed material obtained in step (2) and 450.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 80° C. within 2 minutes and immediately stopped being heated, and the tire mold is opened after 3 minutes to take out a foamed tire.

(4) The foamed tire obtained in step (3) is trimmed to obtain a tire product.

### Comparative Embodiment 2

(1) 450.0 g of Polyethylene Glycol (PEG) 400 with a purity no less than 95%, 1.0 g of UNIQUE® SPERSE 680U used as dispersant, and 3.5 g of BYK®-093 used as defoamer are added into a mixing tank and stirred at a stirring speed of 500 revolutions/minute (r/min) for 15 minutes. 32.0 g of rod-shaped lanthanum oxide with a purity no less than 95% and size specifications of an average length 200 μm, an average width 2 μm, and an average thickness 500 nm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 50° C. to obtain a rod-shaped rare-earth oxide pre-dispersion solution after ceasing stirring by cooling.

(2) 467.0 g of PEG 600 with a purity no less than 95%, 30.5 g of glycerol, 2.0 g of organotin catalyst T-12 with a solid weight content 18±0.5%, which is purchased from Air Products, US, 3.0 g of grade 3 deionized water, and 11.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 550.0 g of the premixed material obtained in step (2) and 450.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 90° C. within 2 minutes and immediately stopped being heated, and the tire mold is opened after 3 minutes to take out a foamed tire.

(4) The foamed tire obtained in step (3) is trimmed to obtain a tire product. A surface of the tire product is shown in FIG. 2, and braking distance data of the tire product is shown in Table 1 and FIG. 4.

### Comparative Embodiment 3

(1) 917.0 g of Polyethylene Glycol (PEG) 400 with a purity no less than 95%, 1.0 g of UNIQUE® SPERSE 680U used as dispersant, and 3.5 g of BYK®-093 used as defoamer are added into a mixing tank and stirred at a stirring speed of 500 revolutions/minute (r/min) for 15 minutes. 32.0 g of rod-shaped lanthanum oxide with a purity no less than 95% and size specifications of an average length 200 μm, an average width 2 μm, and an average thickness 500 nm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 60° C. to obtain a rod-shaped rare-earth oxide pre-dispersion solution after ceasing stirring by cooling.

(2) 30.5 g of glycerol, 2.0 g of organotin catalyst T-12 with a solid weight content 18±0.5%, which is purchased from Air Products, US, 3.0 g of grade 3 deionized water, and 11.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 550.0 g of the premixed material obtained in step (2) and 450.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 80° C. within 2 minutes and immediately stopped being heated, and the tire mold is opened after 3 minutes to take out a foamed tire.

(4) The foamed tire obtained in step (3) is trimmed to obtain a tire product.

### Comparative Embodiment 4

(1) 450.0 g of Polyethylene Glycol (PEG) 400 with a purity no less than 95%, 1.0 g of UNIQUE® SPERSE 680U used as dispersant, and 3.5 g of BYK® 093 used as defoamer are added into a mixing tank and stirred at a stirring speed of 500 revolutions/minute (r/min) for 15 minutes. 32.0 g of non-rod-shaped lanthanum oxide with a purity no less than 95% and a size specification of spherical powder of a diameter 2 μm, which is purchased from Xiamen Institute of Rare Earth Materials Haixi Institute, Chinese Academy of Sciences, is then added, is continually dispersed at a stirring speed of 800 r/min, and is continually stirred for 10 minutes when a temperature of the material reaches 60° C. to obtain a rod-shaped rare-earth oxide pre-dispersion solution after ceasing stirring by cooling.

(2) 467.0 g of PEG 600 with a purity no less than 95%, 30.5 g of glycerol, 2.0 g of organotin catalyst T-12 with a solid weight content 18±0.5%, which is purchased from Air Products, US, 3.0 g of grade 3 deionized water, and 11.0 g of black color paste with a weight concentration of 10±0.5%, which is purchased from Panyu Keytec Color Co., Ltd., Guangzhou, are added into a dispersion tank in sequence and are stirred at a stirring speed of 500 r/min for 10 minutes. The rod-shaped rare-earth oxide pre-dispersion solution obtained in step (1) is then added and continually dispersed at a stirring speed of 800 r/min for 15 minutes to obtain a premixed material.

(3) 550.0 g of the premixed material obtained in step (2) and 450.0 g of N3390 isocyanate used as a curing agent and purchased from Bayer or Desmodur are added into a mixing tank and mixed quickly to obtain a uniform material, and the uniform material is then poured into a tire mold coated with a release agent. The tire mold is heated to raise a temperature of the tire mold to 80° C. within 2 minutes and immediately stopped being heated, and the tire mold is opened after 3 minutes to take out a foamed tire.

(4) The foamed tire obtained in step (3) is trimmed to obtain a tire product.

The following are the test data of the finished tires prepared in Embodiments 1-3 and Comparative Embodiments 1-4. For the tire braking distance test, a 250W rear axle motor was used, with the following test conditions: vehicle speed: 6.5 km/h, voltage: 24.5 V, test load: 73 kg, and slope: 9°. Hardness (Shore A) indicates the softness and hardness of the tire, which is generally used to measure the ride comfort and wear resistance of the tire—excessively high hardness reduces comfort, while excessively low hardness decreases wear resistance. Roughness indicates the friction force with the ground. Under a constant load, increased roughness improves the friction force with the ground, thereby shortening the braking distance on various surfaces. A shorter braking distance indicates better tire grip and a higher safety factor.

TABLE 1
Performance Results of Embodiments and Comparative Embodiments

| | | | Braking Distance (m) | | | |
|---|---|---|---|---|---|---|
| | | | | Floor finish | | Tile Floor |
| | | | | with Grade 3 | | with Grade 3 |
| | Hardness | Roughness | Floor | Deionized | Tile | Deionized |
| | (Shore A) | (μm) | finish | Water | Floor | Water |
| Embodiment 1 | 75 | 2.2 | 1.0 | 1.1 | 1.2 | 1.3 |
| Embodiment 2 | 78 | 5.5 | 0.88 | 0.94 | 0.94 | 1.0 |
| Embodiment 3 | 76 | 3.8 | 0.98 | 1.05 | 1.2 | 1.3 |
| Comparative | 88 | 1.2 | 1.5 | 1.7 | 1.6 | 1.8 |
| Embodiment 1 | | | | | | |
| Comparative | 65 | 4.7 | 1.3 | 1.5 | 1.3 | 1.6 |
| Embodiment 2 | | | | | | |
| Comparative | 68 | 2.5 | 1.4 | 1.6 | 1.4 | 1.7 |
| Embodiment 3 | | | | | | |
| Comparative | 89 | 4.2 | 1.3 | 1.6 | 1.5 | 1.6 |
| Embodiment 4 | | | | | | |

The aforementioned description is merely preferred embodiments of the present disclosure, and the implementation scope of the present disclosure should not be limited thereto. Thus, it is intended that equivalent variations and modifications fall within the scope of the present disclosure provided that they are made in accordance with the patent scope and the content of the specification of the present disclosure.

What is claimed is:

1. An anti-slip rod-shaped rare-earth-modified polyurethane material, wherein:
the anti-slip rod-shaped rare-earth-modified polyurethane material is formed by mixing and curing a premixed material and isocyanate,
the premixed material is prepared by mixing a rod-shaped rare-earth oxide pre-dispersion solution, polyethylene glycol (PEG) 600, glycerol, a catalyst, water, and color paste,
the rod-shaped rare-earth oxide pre-dispersion solution is prepared by mixing PEG400, a dispersant, a defoamer, and rod-shaped rare-earth oxides, and
size specifications of the rod-shaped rare-earth oxides are as follows: a length 100-200 μm, a width 2-15 μm, and a thickness 500 nm-5 μm.

2. The anti-slip rod-shaped rare-earth-modified polyurethane material according to claim 1, wherein:
the rod-shaped rare-earth oxides are at least one of rod-shaped cerium oxide, rod-shaped lanthanum oxide, rod-shaped samarium oxide, rod-shaped neodymium oxide, or rod-shaped yttrium oxide.

3. The anti-slip rod-shaped rare-earth-modified polyurethane material according to claim 1, wherein:
in the rod-shaped rare-earth oxide pre-dispersion solution, a mass ratio of the PEG400, the dispersant, the defoamer, and the rod-shaped rare-earth oxides is 350-450: 1-2:2.5-5:22-32.

4. The anti-slip rod-shaped rare-earth-modified polyurethane material according to claim 1, wherein:
in the premixed material, a mass ratio of the rod-shaped rare-earth oxide pre-dispersion solution, the PEG600, the glycerol, the catalyst, the water, and the color paste is 384-486.5:467-538:30.5-60:1.5-3:2-4:11-15.

5. The anti-slip rod-shaped rare-earth-modified polyurethane material according to claim 1, wherein a mass ratio of the premixed material and the isocyanate is 5-6:4-5.

6. The anti-slip rod-shaped rare-earth-modified polyurethane material according to claim 1, wherein the catalyst is organotin catalyst T-12.

7. A preparation method of the anti-slip rod-shaped rare-earth-modified polyurethane material according to claim 1, comprising following steps:
(1) mixing the PEG400, the dispersant, and the defoamer to obtain a first uniform material, adding the rod-shaped rare-earth oxides into the first uniform material, continually dispersing until a temperature reaches 50-60° C., continually stirring for 8-12 minutes, stop stirring, and cooling to obtain the rod-shaped rare-earth oxide pre-dispersion solution;
(2) mixing the PEG600, the glycerol, the catalyst, the water, and the color paste to obtain a second uniform material, adding the rod-shaped rare-earth oxide pre-dispersion solution obtained in the step (1) into the second uniform material, and continually stirring for 10-15 minutes to obtain the premixed material; and
(3) mixing the premixed material obtained in the step (2) with the isocyanate to obtain a third uniform material, pouring the third uniform material into a mold, heating the mold to raise a temperature of the mold to 70-80° C. within 2 minutes, immediately stopping heating, and opening the mold after 2-4 minutes to obtain a product.

8. A method for preparing an anti-slip tire by adding the anti-slip rod-shaped rare-earth-modified polyurethane material according to claim 1 into a mold.

9. An anti-slip tire, wherein the anti-slip tire is made of the anti-slip rod-shaped rare-earth-modified polyurethane material according to claim 1.
